(19) United States
(12) Patent Application Publication
(10) Pub. No.: US 2013/0290899 A1
(43) Pub. Date: Oct. 31, 2013

(54) OBTAINING STATUS DATA

(71) Applicant: Asaf AMRAN, Rehovot (IL)

(72) Inventor: Asaf AMRAN, Rehovot (IL)

(21) Appl. No.: 13/460,787

(22) Filed: Apr. 30, 2012

(51) Int. Cl. G06F 3/048

(52) U.S. Cl. 715/810; 715/764

(57) ABSTRACT

Examples of the present invention provide systems and method for obtaining status data of a device having a plurality of component parts comprising displaying a visual representation of the device and at least some of its component parts, and in response to a user action selecting a portion of the visual representation performing one of: displaying a visual representation of the portion and subcomponents of the portion, and obtaining and displaying data related to the selected part.

### BACKGROUND

Modern devices and machines are increasingly complex and computerized. This trend has allowed increases in functionality of different devices and the ability to provide detailed information relating to operation and settings of the device. Indeed many different types of machines available today, from printers to automobiles, have the ability to display information and activities on a user interface.

The common user interface paradigm relies on the use of menus or icons to select functions or information. Each menu can be implemented by drop down menu or by “portals” (icons shortcuts). Menus may have several levels wherein each level can open one or more next levels or open an appropriate screen relating to a desired activity or information page.

Thus, the increasing complexity and functionality of machines leads to very complicated menu structures, with deep hierarchies of options. Complex systems may comprise a large number of elements with each element of the system having multiple activities and information to be represented in the menu hierarchy leading to a profusion of menu options.

As a result, access to a desired activity or information option for a machine can take a long time as multiple levels in the menu hierarchy are traversed. Furthermore, the user must remember the path through the menu hierarchy to the desired option, which is likely to lead to mistakes being made. In complex arrangements for a system with many elements there will be a correspondingly large number of options, and therefore the path through the hierarchy for a specific option will be long and complicated. Thus, it will be difficult for a user to find the correct option for a specific element of a large device.

To mitigate some of these issues, menu hierarchies are generally devised on the basis of an underlying logical arrangement. However, it is common for different manufacturers to apply different logical arrangements and therefore the user may be required to learn a different menu option arrangement whenever a different device or machine is used.

Thus, the trend towards greater device complexity has also led to an increase in complexity in the way in which a user interacts with the device. Increasingly poor or complex user interface design leads to user frustration, which may limit the functionality of a machine accessed by a user, or may discourage a user from changing to a device provided by a different manufacturer.

### BRIEF INTRODUCTION OF THE DRAWINGS

Examples, or embodiments, of the present invention are further described hereinafter by way of example only with reference to the accompanying drawings, in which:

FIG. 1 illustrates a user interface for a printer in accordance with an example of the invention;

FIG. 2 illustrates a system for displaying the user interface of FIG. 1;

FIG. 3 illustrates the user interface of FIG. 1 with an element of the printer having been selected;

FIG. 4 illustrates selection of a menu option of the user interface relating to the selected element;

FIG. 5 illustrates an option screen of the user interface for the selected menu item;

FIG. 6 illustrates zooming into an element of the printer using the user interface of FIG. 1; and

FIG. 7 illustrates the user interface of FIG. 1 having zoomed in to a selected element.

### DETAILED DESCRIPTION OF AN EXAMPLE

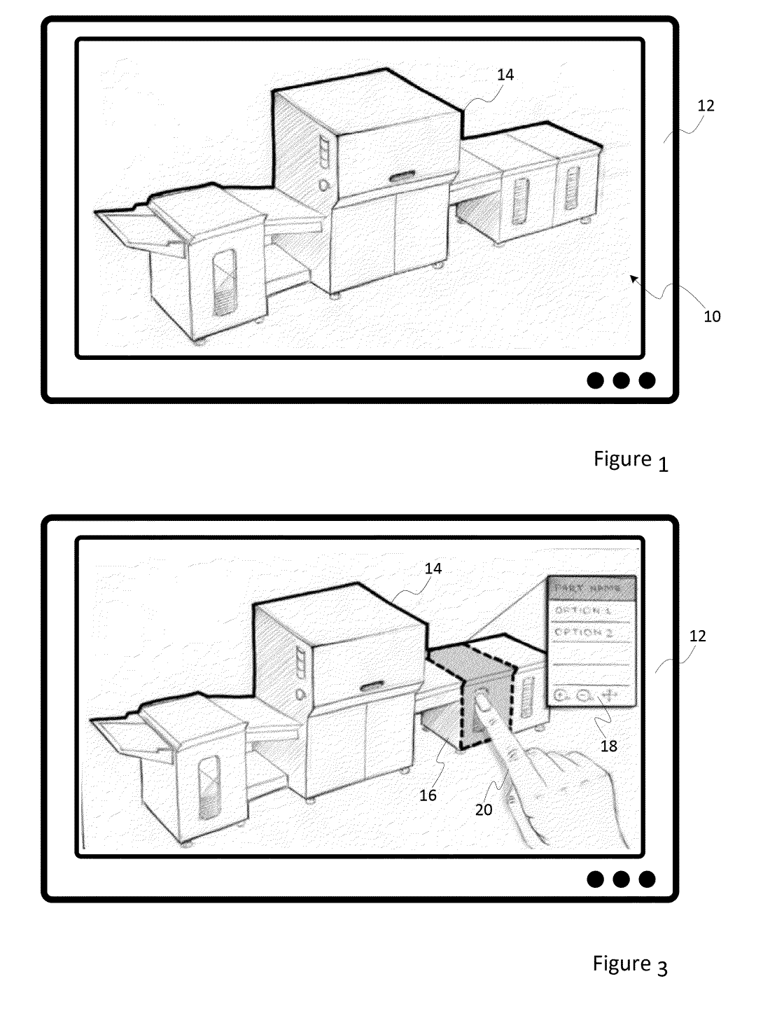

FIG. 1 illustrates a user interface 10 displayed on a screen 12 for a printer apparatus. A graphical representation 14 of the printer is displayed on the screen and provides a basis for interactions between the user and the printer via the user interface 10.

In the disclosed user interface elements and functions can be selected directly from the visualization of the machine, for example the visualization 14 of the printer shown in FIG. 1. Thus, selection of elements via the user interface corresponds with the physical location of the respective function on the machine being controlled or monitored. This provides an intuitive model for interactions between the user and the machine in order for the user to access information or to control certain functions of the machine.

In the following description, the term element relates to a physical module that is part of the machine, activity is an operation performed by the machine and relating to an element, and information is a piece of data related to an element that a user wishes to obtain.

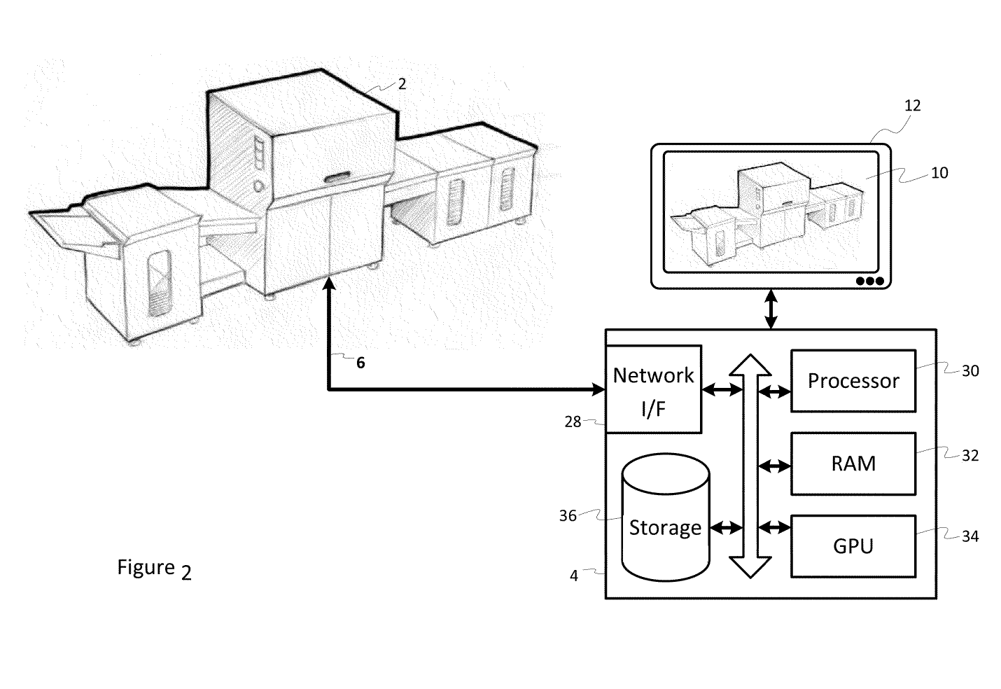

FIG. 2 illustrates a system 4 for generating and displaying the user interface 10 of FIG. 1. The system 4 is coupled to the machine 2, in this example a printing press, via a network 6, and also to display 12 to display the user interface 10. The system 4 includes a network interface 28 to allow the system to communicate with the machine 2 over the network 6. The system 4 further includes a processor 30, memory 32, a graphics processor 34 and storage 36, each of which is coupled to a system bus to allow communication between the modules of the system 4. The system 4 is operable to receive user commands via the user interface 10 and to interface with the machine 2 in order to control activities or obtain information relating to the elements of the machine 2.

An example of a user interaction is shown in FIG. 3. In the example of FIG. 3, the user interface 10 is displayed on a touchscreen 12 allowing the user to physically interact with the visualization 14 displayed on the touchscreen. In this case a user's finger 20 is used to select an element of the printer by touching the corresponding element 16 of the visualization 14 displayed on the screen. In this case, the element 16 is a paper feeder unit of the printer.

Selecting the element 16 of the virtualization 14 a menu, illustrated as floating menu 18 in FIG. 3, is displayed providing access to relevant activities and information for the selected element. In some cases, the act of selecting the element 16 may cause the user interface system to communicate with the printer in order to retrieve relevant information to be displayed on the floating menu 18. For example, for the feeder element selected in FIG. 3, the levels and types of any paper supplies present in the feeder element may be retrieved for display on the floating menu 18.

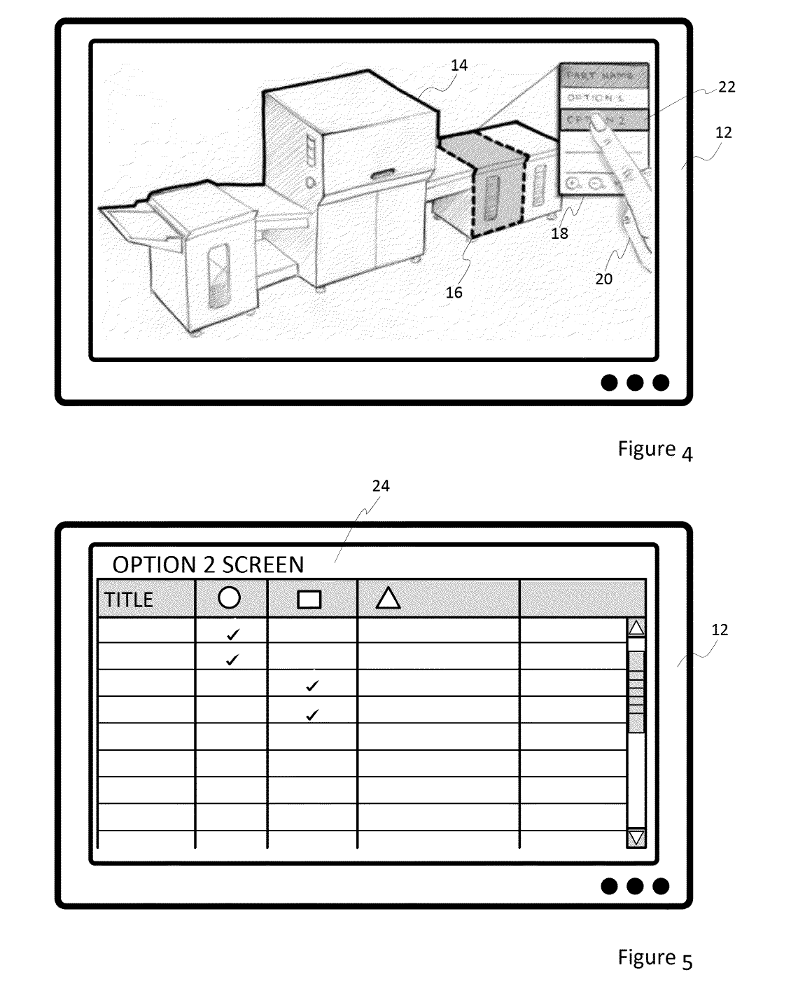

The number of information or activity options that may be presented on the floating menu 18 may be limited, for example, due to available display space. As shown in FIG. 4, the user interface allows a user 20 to select an option 22 from the menu 18 to obtain more information or further options relating to the selected option 22. For example, an option may be presented to display a log of activity relating to a selected element 16. Selecting an option 22 to display further information will cause the user interface 10 to display an option screen 24, illustrated in FIG. 5. The floating menu 18 may provide access to other relevant screens related to the selected element as required.

According to some examples, multiple floating menus 18 may be presented to a user at one time, for example by selection of more than one element 16 of the machine 2 on the user interface 10. In another example, selection of an option in a first floating menu 18 may cause a further menu to be displayed on the user interface allowing further options to be displayed to the user.

For large and/or complex machines, having a large number of elements, displaying all of the elements of the machine at the same time on the user interface shown in FIG. 1 may not be possible. Attempting to display a very large number of elements on a display having a limited resolution can be expected to lead to a very cluttered display which will be unclear and make it difficult for a user to select a specific element of the machine. To allow the management of such large and complicated machines, the user interface 10 provides for the selection of a group of elements.

As illustrated in FIG. 6, a user may ‘zoom in’ to or select a portion of the visualization 14 of the printer to view that portion in greater detail. If the user zooms in on a portion of the visualization 14 that comprises a group of elements, the graphical visualization is updated to provide an expanded view of the individual elements that comprise the group. The user interface 10 may be configured to provide multiple levels of groups of elements allowing a user to zoom in through a first group of elements which includes a second group of elements which may subsequently be selected by the user and zoomed into to display further elements, and/or a further group of elements, etc.

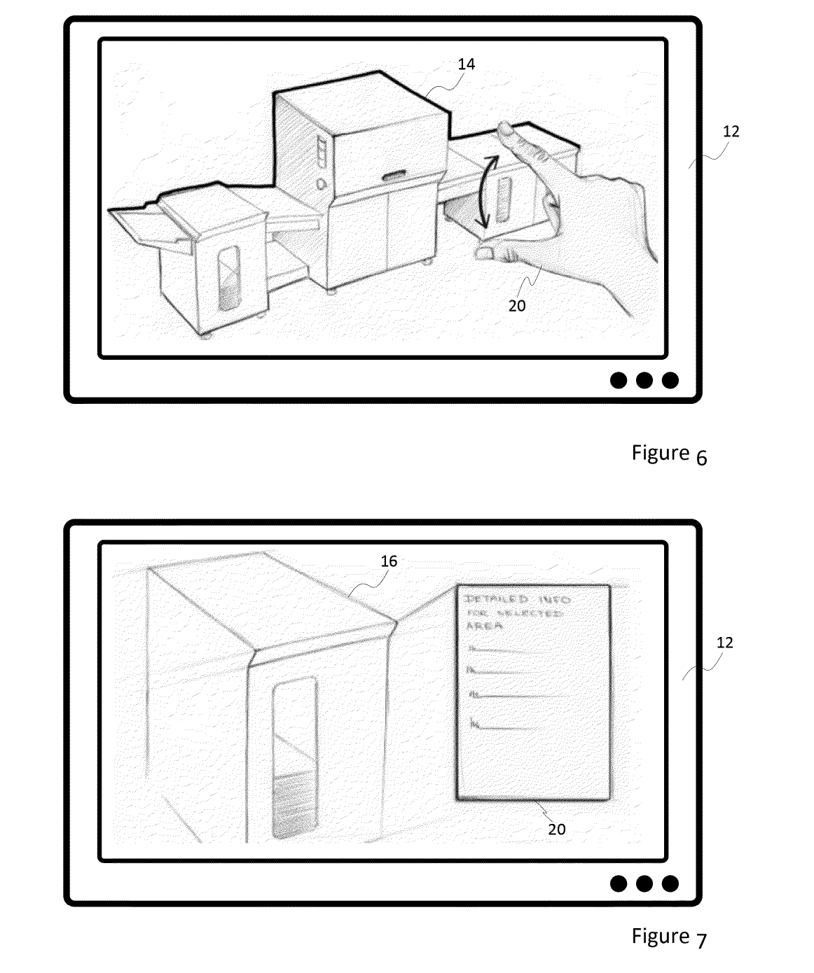

The user may also zoom in to or select a single element 16 of the machine as illustrated in FIG. 7. Selecting the single element 16 in this way displays a view of the element 16 in isolation, and may provide a window 26 with detailed information for the selected element 16, or sub-element depending on the action of the user.

Thus, the user interface 10 presents a graphical visualization 14 of the physical machine to a user, allowing the user to interact with the machine to perform activities or obtain information by selecting an element presented in the user interface in its real location. Once the user selects an element, a floating menu is presented on the user interface 10 and provides access to the relevant activities and information for the selected element.

As an example, a selected element may comprise a pump unit within a larger machine, such as a printer or a motor vehicle. Upon selection of the pump element, the user may be presented with menu options to perform activities such as running a self-test procedure, or starting operation of the pump unit. Further options relating to the pump element may be presented relating to information associated with the pump unit to be displayed to the user, for example pump temperature; pump catalog number; or pump guide. Upon selection the required information can then be retrieved from the pump unit and displayed on the user interface 10.

According to some examples, the graphical visualization 14 may be displayed as a three dimensional (3D) model of the physical machine, rendered to the screen using commonly available graphics processors. The 3D model may be rotated to allow a user to view the graphical representation 14 of the machine 2 from any angle, thereby allowing the user to access elements that are not visible from the front, for example elements located at the rear of the representation 14.

The graphical representation 14 may be arranged to visually display certain information of the device without requiring selection of an element. For example, the graphical representation of the printing press may be shown with an approximate level of paper supplies visible. If display space permits, other information may be displayed alongside the elements, in particular fault indications or warnings may be displayed alongside elements to indicate issues requiring user attention. In particular, the display of events or warnings by a physical location associated with the event or warning allows a user to quickly navigate to the correct location in the user interface 10 to activate corrective action and/or view the relevant information directly from the visualization warning/event notification.

According to some examples, the user interface 10 may provide a search option to allow the user to find an element on the graphical representation 14 for which the user does not know the physical location on the machine 2. The user interface 10 may also be arranged to allow user defined shortcuts to specific elements/groups of elements in order to provide quick access to commonly used functions. Similarly, the level of information presented for each element may be customized such that commonly used information is displayed on selection, while less commonly required information requires the user to make further selections on the user interface 14.

While the above examples have been described in the context of a touch screen user interface, it will be recognized that other methods of interacting with the user interface 10 may be used, for example using a mouse and keyboard.

While within the context of the described examples, floating menus have been used to display selectable options to the user, it will be recognized that other menu types could be used to replace, or in combination with, floating menus. For example, options may be presented as selectable icons, or as a dropdown text box list of options, or in any other appropriate form.

Furthermore, while the examples have been described in the context of user interface for a printing press, the skilled person will recognize that the disclosed user interface can be applied for control of a wide range of machines, including motor vehicles, industrial machines, and consumer devices. Indeed the described invention could be applied to any physical machine that a user wishes to control or monitor via a computer.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, example or example of the invention are to be understood to be applicable to any other aspect, example or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of obtaining status data of a device having a plurality of component parts comprising:
displaying a visual representation of the device and at least some of its component parts; and
in response to a user action selecting a portion of the visual representation performing one of:
displaying a visual representation of the portion and subcomponents of the portion; and
obtaining and displaying information related to the selected part.

2. The method of claim 1, further comprising displaying an option menu related to the selected part.

3. The method of claim 2, wherein the option menu includes one or more activity or information options relating to the selected part.

4. The method of claim 3, further comprising communicating a request to the device in response to a user action selecting an activity or information option.

5. The method of any claim 4, wherein the visual representation of the device comprises a three dimensional representation of the device.

6. The method of claim 5, the method further comprising, in response to a user action, at least one of rotating the displayed visual representation of the device, and zooming the displayed visual representation of the device.

7. The method of claim 1, wherein obtaining data related to the selected part comprises communicating with the device via a network to obtain the required data.

8. The method of claim 1, wherein the visual representation of the device corresponds with a physical arrangement of components of the device.

9. The method of claim 1, wherein displaying a visual representation of the device further comprises displaying selected information relating to component parts of the device alongside the displayed component parts of the device.

10. A system for obtaining status data of a device having a plurality of component parts, the system comprising:
a display;
a memory for storing instructions; and
a processor operable to execute the instructions to thereby cause the system to:
display a visual representation of the device and at least some of its component parts; and
in response to a user action selecting a portion of the visual representation performing one of:
displaying a visual representation of the portion and subcomponents of the portion; and
obtaining and displaying data related to the selected part.

11. The system of claim 10, wherein the display comprises a touchscreen display configured to receive user actions by detection of touch events on the touchscreen display.

12. The system of claim 10, wherein the visual representation of the device comprises a three dimensional visual representation, and the system further comprising a graphics processor for rendering the three dimensional visual representation.

13. The system of claim 10, wherein the device comprises a printing press.

14. The system of claim 10, the system further comprises a network interface for communicating with the device.

15. A computer program product comprising computer program code configured, when executed on a processor, to implement the method of claim 1.
